(19) United States
(12) Patent Application Publication
(10) Pub. No.: US 2026/0146579 A1
(43) Pub. Date: May 28, 2026

(54) MODULAR WIND POWER GENERATION ASSEMBLY

(71) Applicant: Myriad Wind Energy Systems Ltd., Stirling (GB)

(72) Inventors: Paul Ian PIRRIE, Stirling (GB); Peter John TAYLOR, Stirling (GB); Adam HARRIS, Stirling (GB)

(21) Appl. No.: 19/122,986

(22) PCT Filed: Oct. 23, 2023
(86) PCT No.: PCT/EP2023/079469

§ 371 Date: Apr. 21, 2025

(30) Foreign Application Priority Data
Oct. 25, 2022 (GB) 2215766.3

(51) Int. Cl. F03D 1/02; F03D 13/10; F03D 13/20

(52) U.S. Cl. CPC F03D 1/02; F03D 13/112; F03D 13/116; F03D 13/203; F05B 2240/14; F05B 2240/40; F05B 2240/9121

(57) ABSTRACT

The invention provides a modular wind power generation assembly comprising: a support tower; a modular structural framework mounted on the support tower; and a plurality of rotor nacelle assemblies mounted on the framework, wherein individual modules of the framework are connected or attached together to form an array of geometrically equivalent interstitial spacings in the modular structural framework and wherein the area swept by a rotor nacelle assembly rotor in its operation overlies a plurality of interstitial spacings in the framework.

WO

This application is a National Stage application which claims priority from the international application PCT/EP 2023/079469, filed Oct. 23, 2023, which claims priority from GB application No. 2215766.3, filed Oct. 25, 2022. The entirety of aforementioned application is incorporated herein by reference.

### FIELD

The present invention concerns a modular wind power generation assembly, in particular a modular wind turbine, its method of manufacture, and its use.

### BACKGROUND

In recent years, there has been much research & development interest in the use of multi-rotor technology in the wind turbine industry but to date with apparently limited commercialisation, meaning that the industry is still currently dominated by large-component systems which tend to mount a single rotor on a tower, the height of which may typically be around 250-300 m tall. The rotor blades themselves are usually 80-100 m in length.

A multi-rotor wind turbine is one that comprises two or more separate rotors mounted to a common support structure. However, a problem with multi-rotor technology is how to provide effective structural support without falling back into the problems of large-component industrial systems. Conventional approaches tend either to provide a tower and support arms, usually in the form of cantilever beams, or to provide a superstructural lattice for supporting individual rotors.

The first of these conventional approaches is adapted for a relatively small number of rotors but is unlikely to be feasible when extended to a larger number. Additionally, there are physical limits on the length of cantilever beams making up a turbine superstructure before they fail under their own weight.

The second conventional approach typically makes use of an extensive superstructure supporting a plurality of rotors, which causes complexities in manufacturing, transportation, and installation. These superstructures are typically monolithic structures, either requiring large manufacturing efforts on site, transportation logistics for large components (nullifying one of the main benefits of a multi-rotor wind turbine), or to be manufactured and assembled quayside for offshore systems, for example.

WO2010068780A1 discloses an array of fluid energy conversion modules contained in a scalable modular networked superstructure. A plurality of turbines, such as for instance wind turbines, may be disposed in an array, but no structural assembly is disclosed, absent the supporting superstructure.

WO2021034203A1 relates to a wind wall, which is a solid structure made up of one or more wind cells, organised adjacent to one another in a modular manner. This disclosure is primarily concerned with the use of ducting to accelerate wind flow. The material required for the ducting of a system is uneconomical and adds unnecessary loading to the support structure, whilst also complicating the manufacture of the assembly. Furthermore, ducting limits the number of RNAs that can be incorporated into each module.

WO2017108057A1 and WO2019238194A1 both disclose a structure for a multi-rotor wind turbine in which energy generating units are carried by a load carrying structure. The multi-rotor wind turbines comprise a primary structure, the tower, and secondary structures, which extend away from the primary structure and hold energy generating structures. The system described is not modular in nature and is solely related to a multi-rotor system that relies on the use of large cantilever beams, which is not modular in nature.

WO2019172773A1 discloses a wind turbine comprising a frame constructed as a lattice rig upright on a floating pontoon. The system is not modular in nature, nor with the modules comprising the structural assembly, with the lattice rig serving as the structural assembly into which RNAs are placed.

US20060171798A1 discloses a floating power generation assembly comprising floating units equipped with power generation means, floating on a body of water, secured to a solid surface beneath the body of water by an anchor. The system does not decouple the modularity of the support structure and the energy generation means, with a single power generation means being equipped to each module. The system also discloses ducting which is uneconomical and provides unnecessary extra weight.

US20080315592A1 discloses an omni-directional array of wind turbine assemblies, which is positioned upon and about the periphery of the roof of a building. Each wind turbine assembly comprises a self-supporting modular box-shaped housing having an inlet and outlet for accelerating the flow of air therethrough. The system does not describe those in which the modularity is decoupled from the energy generation means, as the energy generation means is integrated within the structural support.

US20090115193A1 and US20170082086A1 disclose examples off tidal water turbines and turbine assemblies. The documents disclose systems in which the turbines are integrated into the support structure and do not decouple any modularity from the overall structure.

Furthermore, US20090115193A1 discloses a system which is not modular in nature and uses a superstructure, constructed of I beams, to support the energy generation structures.

CN107620674A discloses a wind power generation unit element comprising a unit element frame and rotary blades arranged within the unit element frame, a generator rotor and a current exporting element, wherein the generator rotor is arranged in the unit element frame and driven by the rotary blades. The document does not disclose a system wherein the modularity of the support structure and the RNAs are decoupled from one another and further discloses a system comprising a yaw system for each individual module.

JP2001050149A discloses a wind power generator with a small mounting area and large power generating function by rotatably arranging a vertical frame on an intermediate upper part of a strut, and continuously and mutually arranging a plurality of wind turbine units on an upper part of horizontal frames disposed on the lower part of the vertical frame. The system disclosed does not decouple the relationship between the number of rotors and the number of structural modules within the superstructure.

A number of multi-rotor wind turbine design concepts are reviewed in Innovative Turbine Concepts-Multi-Rotor System by Jamieson et al. in Deliverable 1.33 www.innwind.eu/publications/deliverable-reports (August 2015).

Other supporting structures for multi-rotor assemblies are disclosed in “Simplified support structure design for multi-rotor wind turbine systems”, Störtenbecker et al., 2020, Wind Energ. Sci., 5, 1121-1128 and in “Simplified approach for the optimal number of rotors and support structure design of a multi rotor wind turbine system”, Störtenbecker et al., 2020, J. Phys.: Conf. Ser., 1618, 032009. These are all single piece monolithic superstructure designs.

However, to date none of the prior art satisfactorily addresses the question of how to provide a multi-rotor wind energy generation assembly, with effective structural support without reliance on large, unwieldy, complex, insufficiently robust and/or expensive structural composition. Typically, modular systems in the art as described above revolve around modular systems in which the module comprises both the wind turbine rotor and the structural framework. The present invention seeks to provide a more flexible, cost-effective, and versatile modular wind power generation assembly through separation of modularity of the wind turbine rotors and the modularity of the structural framework.

### BRIEF DESCRIPTION OF THE DRAWINGS

FIG. 1 shows a schematic view of a modular wind turbine assembly in accordance with the invention, from both the front and the side. FIG. 1A shows a front view of the multi-rotor wind turbine assembly. FIG. 1B shows a side view of the multi-rotor wind turbine assembly.

FIG. 2 shows schematically a comparative modular wind turbine assembly, in which each module comprises a rotor and associated structural framework.

FIG. 3 shows schematically the modular wind turbine assembly, in accordance with the invention, in which each rotor is supported by several modules of the associated structural framework.

FIG. 4 shows schematically the modular wind turbine assembly, in accordance with the invention, in which structural framework module and the supporting tower comprise multiple component parts.

FIGS. 5A and 5B show schematically an exemplary modular wind turbine assembly, in accordance with the invention, in which each module comprises an array of rotors and the associated structural framework, from the front and the side. FIG. 5A shows a front view. FIG. 5B shows a side view.

FIG. 6 shows schematically exemplary modular wind turbine assembly of FIG. 5, from above.

FIG. 7 shows schematically the modular structural framework of an exemplary modular wind turbine assembly, in accordance with the invention, and its component parts.

FIGS. 8A and 8B show schematically an alternative modular structural framework of an exemplary modular wind turbine, in accordance with the invention, in which the framework is attached to the support tower by means of an interfacing subsystem. FIG. 8A shows the modular structural framework comprising an interfacing subsystem in its constructed form. FIG. 8B shows the modular structural framework comprising an interfacing subsystem, highlighting the modularity of the structural framework.

### DETAILED DESCRIPTION

According to a first aspect of the present invention there is provided a modular wind power generation assembly comprising: a support tower; a modular structural framework mounted on the support tower; and a plurality of rotor nacelle assemblies mounted on the modular structural framework, wherein individual modules of the framework are connected or attached together to form an array of geometrically equivalent interstitial spacings in the framework and wherein the area swept by a rotor nacelle assembly rotor in its operation overlies a plurality of interstitial spacings in the framework.

The invention provides for effective decoupling of the logistical considerations concerning selection of framework modules—their number, type, weight, orientation, for example on the one hand—and those concerning rotor nacelle assemblies (RNAs)—their number, size, operational capability, for example, on the other. To take one straightforward example, the invention allows flexibility with regards to the construction of the framework and the number and/or positioning of the RNAs upon it.

Thus, the array may be an array of triangles, squares, rectangles, hexagons or substantially any tessellating shape.

The RNAs are preferably mounted on the framework between neighbouring interstices, more preferably on, adjacent to or towards the nodes of the framework between multiple neighbouring interstices.

In most preferred embodiments, the RNAs are mounted adjacent to the nodes, as this provides greater access to the framework during assembly. Attachment on a node whilst possible, is a challenge, due to the intersection of multiple components.

Consequently, the invention provides a modular wind power generation assembly in accordance with the above comprising a multiplicity of RNAs and an associated modular structural framework comprising a multiplicity of structural framework modules and means for connecting structural framework modules together to provide the overall structural framework assembly.

In this context, it is to be understood that that the term “associated” means that the RNA is attached, or connected, to the modular structural framework.

Decoupling components means that a multiplicity of structural framework modules may be collectively associated with a particular or individual RNA. Decoupling the inherent modularity of the RNAs present in the multi-rotor wind turbine concept and the modularity of the supporting structure provides much greater flexibility in the construction and design of wind power generation assemblies.

In particular embodiments, the present invention may provide a modular wind power generation assembly comprising a multiplicity of RNAs and a multiplicity of structural framework modules and means for connecting framework modules together to provide a structural assembly, on which the RNAs are mounted.

The invention therefore permits the assembly of multi-component energy generation systems from individual modular units. Importantly, the structural basis of the assembly is provided by the individual structural framework modules themselves, with the at least one RNA being supported across multiple structural modules, and there is no need to provide an underlying superstructure on which to mount individual energy generation units.

In some cases, however, it may be desirable to provide a superstructure on which the modular units may be mounted.

The modular structural framework may be adapted so that individual modules can be paired together in a connective manner by means of interconnection or mutual attachment, so that each such pairing is effected solely by the structural framework of each module, preferably not by any adjacent superstructure. The associated modular structural framework may be directly associated with one of the multiplicity of RNAs, or it may be associated with more than one of the multiplicity of RNAs. Greater flexibility in construction and component size is facilitated by the decoupling of the modularity of the structural framework and the RNAs.

By being “paired together in a connective manner” is meant structural pairing. Having been so paired, individual structural framework modules within each pair may then be further paired, and the overall modular structural framework assembly may be constructed by the successive pairing of individual modules or pairs or larger groups thereof.

Each of the individual modules of the structural framework may be further subdivisible into multiple component parts, such as beams, struts and the like. In such an embodiment, each structural framework module may be constructed from it's component parts on-site, increasing flexibility of construction and transportation of components to the site of the modular wind power generation assembly.

The flexibility in the association of the multiplicity of RNAs with the associated modular structural framework may permit close pairing between modules such that the energy generation capability of the assembly may be enhanced or maximised with respect to its surface area. Preferably, in the assembly of the invention there is a substantial absence, or absence, of ducting adjacent the RNAs such that close spacing of the components within the framework can be achieved. These two factors collectively facilitate enhancement or maximisation of energy generation capability per unit area of the assembly.

The “operational surface area” of an RNA is the total surface area swept by the moveable, oscillatable or rotatable member(s) of the RNA. (Typically, by this we mean the total surface area swept by the rotating blade(s) or rotor(s) of the RNA.) Preferably the collective operational surface area of the RNAs accounts for at least about 50%, preferably at least about 60%, more preferably at least about 70%, still more preferably at least about 80% and most preferably at least about 85% or at least about 90% of the surface area of the structural assembly.

It will be seen that the modular wind power generation assembly according to the first aspect of the present invention is modular not only in the sense that a multiplicity of RNAs may be supported in a single system, but also in that the supporting structural framework is modular in nature, being constructed from a multiplicity of individual structural framework modules. It will be understood that there is no direct connection between the number of RNAs and the number of structural framework modules.

Each RNA typically comprises a moveable element cooperating with mechanical transmission means, generator means, and electrical power transmission means. These elements when applied to a wind turbine may collectively be referred to as a “rotor-nacelle-assembly” (RNA).

The RNAs may comprise an energy capturing device, such as a wind turbine rotor, a drive train that may or may not include a gearbox, an energy generator device, such as a generator, a means of converting electrical power, such as a power electronic converter, a supporting framework such as a bedplate, and protection from the elements such as a nacelle cover. The individual components may be detachable from one another.

One of the core advantages multi-rotor wind turbines (MRWT) is that smaller components can be used, simplifying manufacturing, logistics and transport. However, designing the support structure using large components, or as one monolithic superstructure nullifies this benefit somewhat, as those large components would require highly specialised transport, manufacturing and lifting/installation equipment. Advantageously, the modularity of the supporting structural framework according to the present invention reduces reliance on the use of specialised transportation equipment; reduces the requirement of large lifting equipment to be used during installation; reduces the requirement of specialised manufacturing techniques-with concomitant reduction in supply chain bottlenecks; and opens up hard to reach sites that have previously been deemed infeasible due to access issues associated with challenges in transportation of large components parts.

The modular wind power generation assembly according to the present invention presents numerous additional advantages over the systems in the art. The decoupling of the components of the assembly means that there is a far broader array of construction options available, greatly increasing the flexibility of the present system. In conventional systems, for example, wherein the modules contain both the wind turbine and the structural framework, the size of the wind turbine is significantly limited, as the diameter of the rotor must be able to fit onto standard transportation, which is commonly only a few meters in height and width. The assembly of the present invention avoids this problem by decoupling modularity of the RNAs from the modularity of the structural framework. As a result, the rotor size, for example, is not limited at all by the size of the structural framework modules, but is now limited by the size of blades that can fit on standard transportation.

The assembly is further advantageous as the decoupling of the modularity of the RNAs from the modularity of the structural framework facilitates reductions in the use of redundant materials. For example, by decoupling the modularity of the components from one another, the use of redundant material in the support structure may be minimised, hence facilitating a more efficient design, which reduces the amount of projected front facing area of the support structure, which, in turn, reduces the loading on the structure caused by the wind in high wind conditions.

Furthermore, the nature of the assembly of the present invention may permit the mounting of RNAs at any point on the structural framework. RNAs may be mounted on, adjacent to or towards the nodes of the structural assembly. A configuration where the RNAs are mounted close to the nodes is advantageous as it provides improved structural support to the structural assembly, whilst also providing greater practicality of access to the structural framework module to which it is associated.

According to a second aspect of the present invention there is provided a method of installation of a modular wind power generation assembly comprising providing a multiplicity of RNAs, a modular structural framework, and a means for connecting the RNAs to the modular structural framework.

In further embodiments of the invention according to the second aspect of the invention there is provided a means for connecting components of the structural framework modules together, and connecting together a plurality of such components to provide the modular structural framework for a structural assembly for wind power generation.

The connecting together of the plurality of structural framework modules to form the modular structural framework, and the plurality of RNAs may take place on or off the site of use of the assembly, but preferably, takes place at least partly on-site.

According to a third aspect of the present invention there is provided the use of a modular wind power generation assembly in accordance with the foregoing description for the production of green power.

One of the core advantages of a modular wind power generation assembly (with respect to conventional assemblies), is that smaller components can be used, simplifying manufacturing, logistics, installation, maintenance operations, and transport.

Scaling down components to a more manageable size reduces reliance on the use of specialised transportation, installation and maintenance equipment; reduces the requirement of large lifting equipment to be used during installation; reduces the requirement of specialised manufacturing techniques-with concomitant reduction in supply chain bottlenecks; and opens up hard-to-reach sites that have previously been deemed infeasible due to access issues.

Modularity may take several different configurations. Structural framework modules may be easily connected and installed on-site, but in some cases groups of structural framework modules may be connected off-site first. In some embodiments, the RNAs are modular in the sense not only that multiple RNAs may be cooperatively provided together, but also in that each RNA may be supported by a modular structural framework such that there exists modularity not just of the RNAs but also of the supporting structural framework for the assembly.

The modular energy generation assembly is supported by a support tower, which supports the structural framework and the RNAs. In some embodiments, the support tower may be mounted on a floating platform, in alternative embodiments, the support tower may be mounted on land.

The tower may comprise a yaw system to allow the entire structure to align with the wind, for example. In such embodiments, energy generation may be maximised. Whilst it is possible for individual RNAs to be provided with a yaw system this is not preferred owing to cost and complexity.

The height of the assembly may be adjusted to elevate the assembly into higher wind-speed environments. Height adjustments may be achieved by alterations to the height of the support tower, either pre-or post-assembly. The support tower itself may be of modular construction.

The modular structural framework may be mounted directly on the support tower. Alternatively. the modular structural framework may be mounted on the support tower via an interfacing subsystem. In some embodiments the interfacing subsystem is configured to align the plurality of rotor nacelle assemblies mounted on the modular structural framework with the prevailing wind direction. The interfacing subsystem may be a yaw system.

The modular structural framework may be manufactured from any suitable material such as metal, metal alloys, steel, aluminium, scandium and alloys thereof, fibre-reinforced plastics, thermoplastic resins and composite materials.

The modular structural framework may have a polygonal cross-section, preferably a tessellating cross-section. In an assembly according to the invention preferably each structural framework module within the body of the assembly (except around its edges) is paired together in a connective manner to a plurality of other structural framework modules; preferably to n other modules, wherein n is the number of sides of the structural framework polygon.

The structure may comprise a modular structural framework or lattice supported on the support tower. The structural framework may have a layered structure the interstices of which accommodate the RNA, at least in part (in the case of a wind turbine rotor it may be preferred for the rotor itself to extend outside the accommodating space formed by the interstices of the layered structural framework). The structural framework layers may be braced for additional strength.

Individual structural framework modules may be paired together structurally. Structural pairing of structural framework modules of the modular wind power generation assembly may be effected by mechanical connection, for example bolted, flanged, threaded, bracketed, clamped, interlocking, hook and loop hinge, pinned and/or wedged connections. Adhesive or other form of chemical attachment such as welding may also be envisaged.

Individual RNAs may be attached, or connected, to the modular structural framework by mechanical connection, for example bolted, flanged, threaded, bracketed, clamped interlocking, hook and loop hinge, pinned and/or wedged connections.

The modular wind power generation assembly may be land or water based. It may be utilised for onshore or offshore fixed bottom systems, or floating systems. In embodiments where the modular wind power generation assembly is a floating system, the modular structural framework may be mounted directly onto a floating superstructure, or may consist of multiple support towers, and it may be tethered to the sea or riverbed by cabling or other suitable means.

The RNA rotor may comprise at least one blade. In preferred embodiments the rotor may comprise one blade, two blades, three blades, four blades, or optionally five blades.

The invention will now be more particularly described with reference to the figures in which:

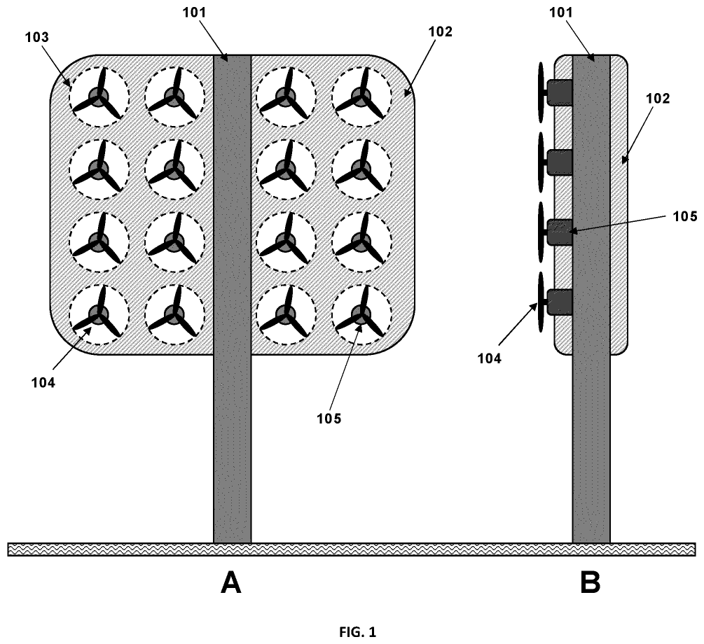

Referring to FIGS. 1A and 1B, there is shown a schematic view of a modular wind turbine assembly, in accordance with the invention, from both the front (1A) and the side (1B). There is shown a schematic view of a modular multi-rotor wind turbine assembly (100) comprising a supporting tower (101), which holds a support structure (102) on which are mounted 16 individual modular wind turbines (rotor-nacelle assemblies) (103) each comprising a wind-responsive rotor (104) connected to a generator (105) and supplying power to a remote location via cabling or other means of power transmission associated with each module. Each rotor (104) may comprise at least one blade.

FIG. 1A shows a front view, of the multi-rotor wind turbine assembly.

FIG. 1B shows a side view of the multi-rotor wind turbine assembly.

It will be apparent that many other configurations may be envisaged.

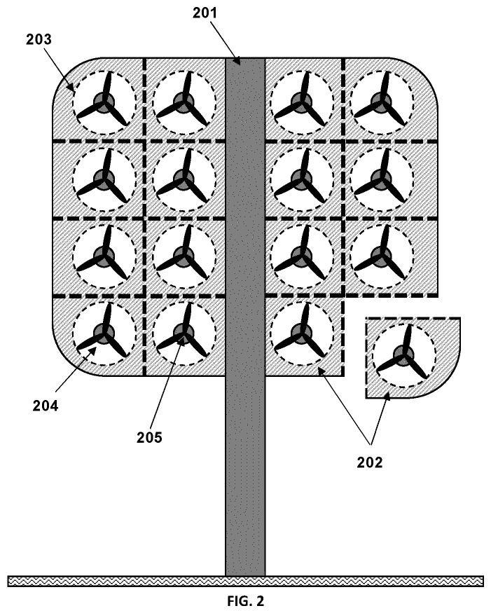

Referring to FIG. 2 there is shown a schematic view of a comparative modular wind turbine assembly, in which each module comprises a rotor and associated structural framework. Each modular multi-rotor wind turbine assembly (200) comprises a supporting tower (201), which holds a support structure which holds 16 individual modular units (rotor-nacelle assemblies) (203) each comprising a wind-responsive rotor (204) connected to a generator/turbine (205) and supplying power to a remote location via cabling or other means of power transmission associated with each module, and associated structural framework that forms the support structure. Each rotor (204) may comprise at least one blade.

In the comparative embodiment of FIG. 2 the advantage of the invention in “decoupling” considerations concerning the number, type, weight, orientation, for example, of structural framework modules from similar considerations concerning the RNAs is not realised. There is simply provided one RNA associated with one modularised framework component, leaving little design flexibility and not allowing for any of the following advantages of the invention:
·in a comparative system comprised of modules containing both the wind turbine and the structural framework, then the size of the wind turbine is significantly limited. The diameter of the rotor must be able to fit onto standard transportation, which is often only a few meters in height and width. With the inventive system, the maximum rotor size can be at least doubled with respect to the comparative design, since the rotor blades can be provided (and, importantly, transported) separately from the structural framework modules.
In the inventive arrangement it is possible to mount the RNAs on or close to the nodes of the structure, providing better structural support.
The inventive arrangement minimises the use of redundant structural material.
An important consideration for the support structure is the loading on the structure caused by the wind in extreme 50 year storm events. It is important to reduce the amount of projected front facing area of the support structure. By the inventive decoupling of the modularity of the support structure from the modularity of the RNAs, the use of redundant material in the support structure can be minimised, hence allowing a more efficient design.

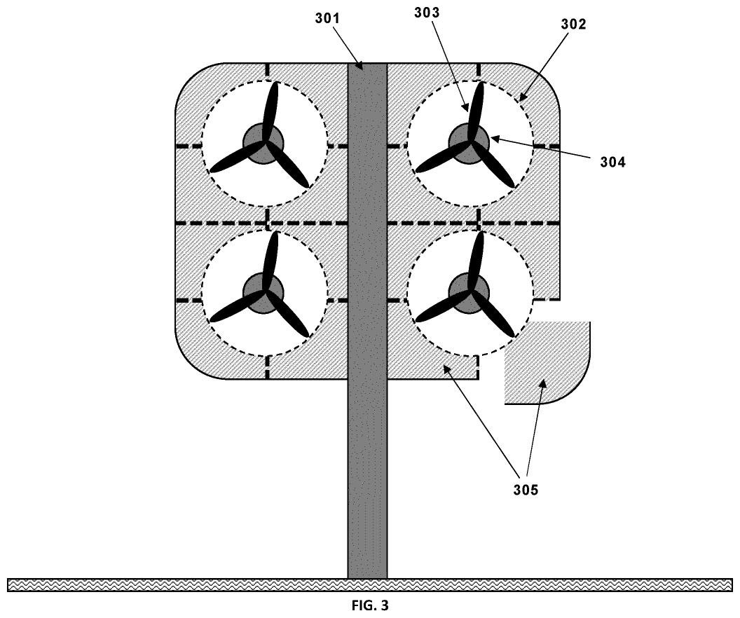

Consequently, referring to FIG. 3 there is shown a schematic view of a modular wind turbine assembly, in accordance with the invention, in which each rotor is supported by several modules of the associated structural framework. Each modular multi-rotor wind turbine assembly (300) comprises a supporting tower (301), which holds a number of individual wind turbines (rotor-nacelle assemblies) (302) each comprising a wind-responsive rotor (303) connected to a generator/turbine (304) and supplying power to a remote location via cabling or other means of power transmission associated with each wind turbine. Each modular wind turbine (302) may be supported by a multiplicity of structural framework support modules (305). Each structural framework module (305) may encompass the supporting material in the area it covers.

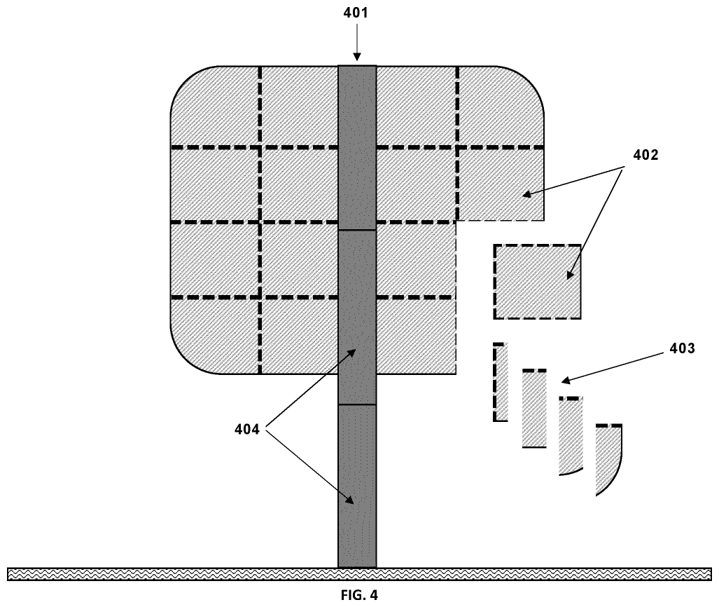

Referring to FIG. 4 there is shown a schematic view of a modular wind turbine assembly, in accordance with the invention, in which each structural framework module (402) may be further subdivisible into much smaller modular components (403), such as individual beams, struts, bolts or weldments. Furthermore, the supporting tower (401) itself may also be of modular construction, comprised of components (404). For simplicity the wind turbine assemblies are omitted and only the structural framework is shown.

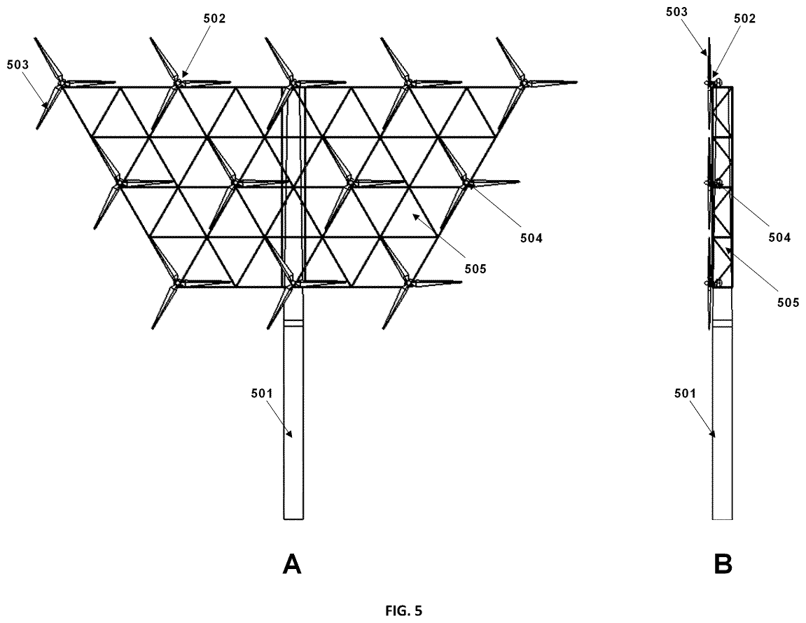

Referring to FIGS. 5A and 5B there is shown a schematic view of an exemplary modular wind turbine assembly, in accordance with the invention, from the front (5A) and the side (5B). The modular assembly (500) comprises a supporting tower (501), an array of wind turbines (502), each comprising a wind-responsive rotor (503) connected to a generator (504) and supplying power to a remote location via cabling or other means of power transmission. The turbines (502) are mounted on an array of structural framework modules constructed of a weldment of circular hollow sections (505), which link together to form the overall superstructure to which the turbines (502) are mounted. The turbines (502) may be mounted at or close to the intersections of the structural framework modules (505). The supporting tower (501) components may or may not be modular. In this example, the structural framework modules may be connected together to form, for example a triangular framework module, which can then in turn be connected together to form the superstructure.

FIG. 5A shows a view from the front of the exemplary modular wind turbine assembly, where the wind-responsive rotors (503) and their associated generator (504) (the RNA) are mounted close to the nodes of the structural modules (505).

FIG. 5B shows a view from the side of the exemplary modular wind turbine assembly.

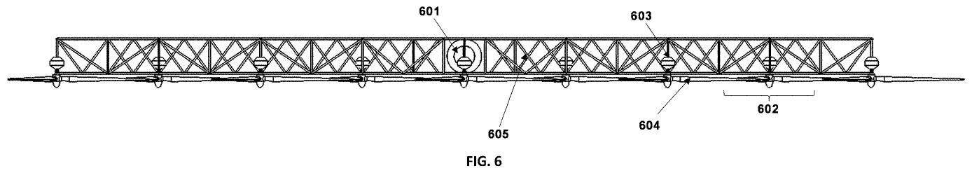

Referring to FIG. 6 there is shown a schematic top plan view of an exemplary modular assembly, in accordance with the invention, in which the array of rotors is supported by the modular structural framework. The modular assembly (600) comprises a supporting tower (601), an array of wind turbines (602), each comprising a wind-responsive rotor (604) connected to a generator (603) and supplying power to a remote location via cabling or other means of power transmission. The turbines (602) are mounted on an array of structural framework modules (605), which link together to form the overall superstructure to which the turbines (602) are mounted.

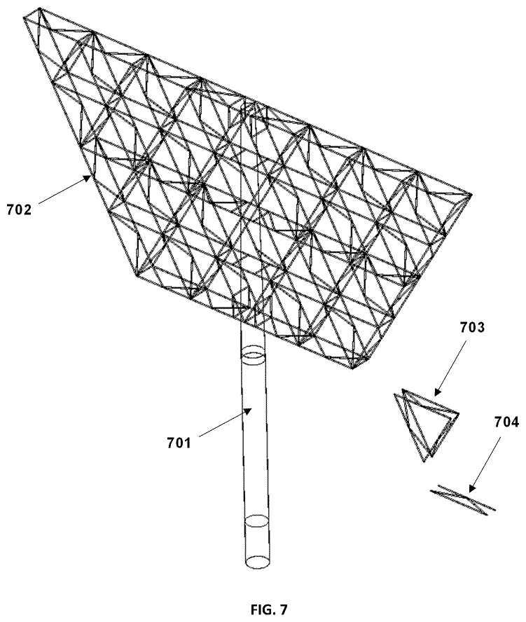

Referring to FIG. 7 there is shown a schematic view of the modular structural framework of the exemplary modular wind turbine assembly, in accordance with the invention, as described in FIGS. 5 and 6, illustrating how each module is further subdivisible into its component parts. The assembly (700) comprises a supporting tower (701) which supports a modular structural framework (702). The structural framework (702) is constructed from a plurality of individual modules (703) connected by the weldment of circular hollow triangular-sections which link together to form the overall structure to which the turbines may be mounted. Each module (703) may be further subdivisible into much smaller modular components (704), such as individual beams, struts, bolts or weldments. Furthermore, the supporting tower (701) itself may also be of modular construction.

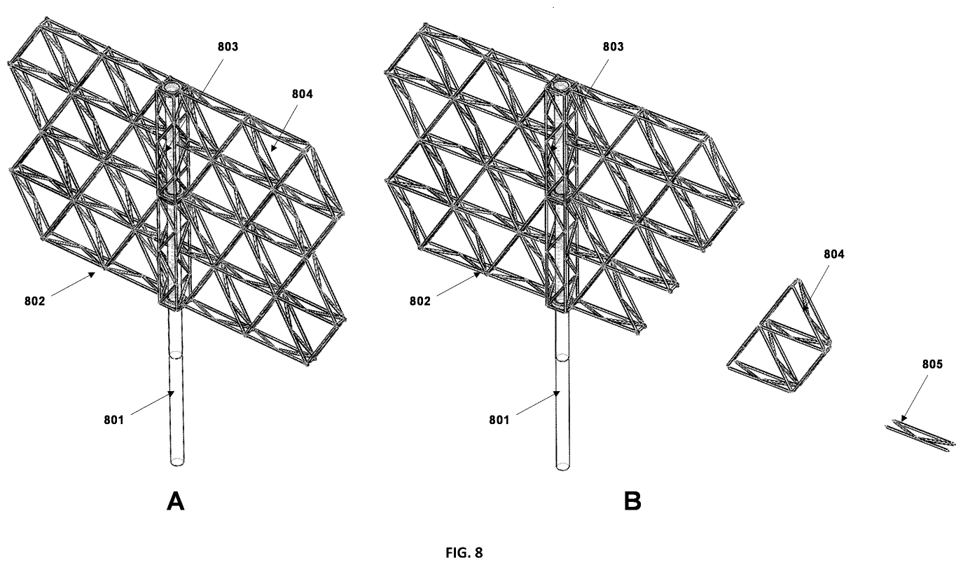

Referring to FIGS. 8A and 8B there is shown a schematic view of an alternative modular structural framework of an exemplary modular wind turbine, in accordance with the invention, in which the framework is attached to the support tower by means of an intermediate structure. The assembly (800) comprises a supporting tower (801) which supports a modular structural framework (802). The structural framework (802) is attached to the support tower (801) by means of an interfacing subsystem (803). The interfacing subsystem (803) is attached directly to the tower (801), particularly the yaw system, and provides a means for the structural framework (802) to be mounted. The structural framework (802) is constructed from a plurality of individual modules (804) connected by the weldment of circular hollow triangular-sections which link together to form the overall structure to which the turbines may be mounted. Each module (804) may be further subdivisible into much smaller modular components (805), such as individual beams, struts, bolts or weldments. Furthermore, the supporting tower (801) itself may also be of modular construction.

FIG. 8A shows the modular structural framework comprising an interfacing subsystem in its constructed form.

FIG. 8B shows the modular structural framework comprising an interfacing subsystem, highlighting the modularity of the structural framework.

1. A modular wind power generation assembly comprising:
a support tower;
a modular structural framework mounted on the support tower; and
a plurality of rotor nacelle assemblies mounted on the modular structural framework,
wherein the modular structural framework comprises a plurality of structural framework modules.
wherein individual modules of the modular structural framework are connected or attached together to form an array of geometrically equivalent interstitial spacings in the modular structural framework, and
wherein the area swept by a rotor nacelle assembly rotor in its operation overlies a plurality of interstitial spacings in the modular structural framework.

2. The modular wind power generation assembly according to claim 1, wherein the plurality of rotor nacelle assemblies are mounted on the modular structural framework between neighbouring geometrically equivalent interstitial spacings.

3. The modular wind power generation assembly according to claim 2, wherein the plurality of rotor nacelle assemblies are mounted on, adjacent to or towards, nodes of the modular structural framework between multiple neighbouring geometrically equivalent interstitial spacings.

4. The modular wind power generation assembly according to claim 1, comprising:
plurality of rotor nacelle assemblies, each rotor nacelle assembly is associated with a structural framework module, and means for connecting structural framework modules together to provide the modular wind power generation assembly.

5. The modular wind power generation assembly according to claim 4, wherein the means for connecting structural framework modules together to provide the structural assembly comprises means for the direct connection of one structural framework module to another.

6. The modular wind power generation assembly according to claim 1, wherein the plurality of structural framework modules are collectively associated with a particular or individual rotor nacelle assembly.

7. The modular wind power generation assembly according to claim 1, wherein the structural framework modules framework-are adapted so that individual structural framework modules can be paired together in a connective manner by means of interconnection or mutual attachment, without recourse to any adjacent superstructure.

8. The modular wind power generation assembly according to claim 7, wherein individual structural framework modules are paired together structurally.

9. The modular wind power generation assembly according to claim 7, wherein structural pairing of structural framework modules is effected by:
a. mechanical connection; and/or
b. adhesive or welding.

10. The modular wind power generation assembly according to claim 7, wherein individual structural framework modules within each pair are further paired, and the modular structural framework is constructed by the successive pairing of individual structural framework modules or pairs or larger groups thereof.

11. The modular wind power generation assembly according to claim 1, wherein the operational surface area of the rotor nacelle assemblies accounts for at least 50%, of the surface area of the modular structure framework.

12. The modular wind power generation assembly according to claim 1, wherein each structural framework module has a polygonal cross-section.

13. The modular wind power generation assembly according to claim 1, wherein each structural framework module that is not located around an edge of the modular structural framework is paired together in a connective manner to a plurality of other structural framework modules.

14. The modular wind power generation assembly according to claim 1, further comprising height selection means for selecting a height of the assembly.

15. The modular wind power generation assembly according to claim 14, wherein the height selection means are provided by the support tower.

16. The modular wind power generation assembly according to claim 1, wherein the support tower is of modular construction.

17. The modular wind power generation assembly according to claim 1, wherein the modular structural framework is mounted on the support tower via an interfacing subsystem.

18. The modular wind power generation assembly according to claim 17, wherein the interfacing subsystem is configured to align the plurality of rotor nacelle assemblies mounted on the modular structural framework with a prevailing wind direction, optionally wherein the interfacing subsystem is a yaw system.

19. The modular wind power generation assembly according to claim 1, wherein each rotor nacelle assembly comprises:
mechanical transmission means;
a moveable element cooperating with the mechanical transmission means;
generator means; and
electrical power transmission means.

20. A method of installation of a modular wind power generation assembly, comprising:
connecting together the support tower, the modular structural framework and the plurality of rotor nacelle assemblies of claim 1 to provide a modular wind power generation assembly.

21. The method of installation of a modular wind power generation assembly according to claim 20, further comprising:
connecting together individual components of the modular structural framework to provide the modular structural framework, optionally wherein the individual components are modules.

22. (canceled)

23. A modular wind power generation assembly comprising:
a support tower;
a modular structural framework mounted on the support tower; and
a plurality of rotor nacelle assemblies mounted on the modular structural framework,
wherein the modular structural framework comprises a plurality of structural framework modules,
wherein individual modules of the modular structural framework are connected or attached together to form an array of geometrically equivalent interstitial spacings in the modular structural framework, and
wherein each rotor nacelle assembly has an operational surface area and wherein the total operational surface area of the rotor nacelle assemblies accounts for at least 60% of the surface area of the modular structural framework.
